(19) United States
(12) Patent Application Publication
(10) Pub. No.: US 2003/0212174 A1
(43) Pub. Date: Nov. 13, 2003

(54) Free-flowing polyester molding composition

(75) Inventors: Heinrich Peirick, Coesfeld (DE); Hans-Gunter Lohkamper, Haltern (DE); Sonja Bollmann, Haltern (DE); Harald Hager, Recklinghausen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Marl (DE)

(21) Appl. No.: 10/340,663

(22) Filed: Jan. 13, 2003

(30) Foreign Application Priority Data
Jan. 11, 2002 (DE) 102 00 804.3

(51) Int. Cl. C08K 5/09; C08K 3/04; C08K 3/34

(52) U.S. Cl. 524/287; 524/495; 524/449; 524/451

(57) ABSTRACT

A molding composition which comprises the following components:

a) from 95 to 99.5 parts by weight of a thermoplastic aromatic polyester,

b) from 5 to 0.5 parts by weight of a monocarboxylic acid, where the total of the parts by weight of a) and b) is 100;

c) from 0.5 to 60% by weight, based on the molding composition, of particulate, lamellar and/or fibrous additives, selected from fillers, pigments, reinforcing materials, additives which give the molding composition antielectrostatic properties or electrical conductivity, nucleating agents, and particulate flame retardants, where the solution viscosity of the resultant polyester molding composition, measured as J value according to DIN 53 728/ISO 1628/Part 5, is in the range from 50 to 80 cm³/g, and the melt index of the molding composition, measured as MVR at 250° C./5 kg is from 12 to 60 cm³/10 min, exhibits a good compromise between flowability and mechanical properties, and can be processed to give injection moldings with small dimensions.

### BACKGROUND OF THE INVENTION

1. Field of the Invention

The invention relates to a free-flowing molding composition, in particular for injection molding, and also to a molding produced from this molding composition.

2. Description of the Background

In electrical engineering and in the electronics industry the trend is toward ever smaller components. With this, there is a constant increase in requirements for the flowability of plastics. These requirements are particularly critical when the molding composition comprises fillers or reinforcing materials, with resultant considerable reduction in flowability.

One possible way of improving the flowability of plastics is to reduce the molecular weight. However, there are certain limits here, since if the molecular weight is reduced too drastically there is also impairment of mechanical properties.

When preparing polyester molding compositions it is not practical to start from a specially prepared grade of polyester tailored specifically for this purpose, since cost-related factors would make this type of intervention in the production process unacceptable, especially where a plant operates continuously. Instead, it is desirable to start from a standard grade of polyester and to reduce the molecular weight while compounding.

U.S. Pat. No. 4,882,375 uses the sulfonate salt of a mono- or dicarboxylic acid for this purpose. However, its stated reduction in melt viscosity is far from sufficient for the production of injection moldings with small dimensions. The use of sulfonated dicarboxylic acids appears to be more efficient than that of sulfonated monocarboxylic acids.

Starting from this prior art, an object was to develop a polyester molding composition which exhibits a significantly more marked reduction in melt viscosity or improvement in flowability, without any excessive impairment of the mechanical properties of the molding composition.

### SUMMARY OF THE INVENTION

This object has been achieved by means of a molding composition which comprises the following components:

a) from 95 to 99.5 parts by weight of a thermoplastic aromatic polyester,

b) from 5 to 0.5 parts by weight of a monocarboxylic acid, where the total of the parts by weight of a) and b) is 100;

c) from 0.5 to 60% by weight, in each case based on the molding composition, of particulate, lamellar and/or fibrous additives, selected from fillers, pigments, reinforcing materials, additives which give the molding composition antielectrostatic properties or electrical conductivity, nucleating agents, and particulate flame retardants,

d) from 0 to 30% by weight of a non-particulate flame retardant,

e) from 0 to 20% by weight of a synergist, and

f) from 0 to 5% by weight of other additives and/or processing aids, where the solution viscosity of the resultant polyester molding composition, measured as J value according to DIN 53 728/ISO 1628/Part 5, is in the range from 50 to 80 cm³/g, the melt index of the molding composition, measured as MVR at 250° C./5 kg to DIN EN ISO 1133 is from 12 to 60 cm³/10 min.

The invention also provides moldings which have been produced using this molding composition, a method of molding, and products of the method.

### DETAILED DESCRIPTION OF THE INVENTION

The invention is a molding composition which comprises the following components:

a) from 95 to 99.5 parts by weight, preferably from 96 to 99 parts by weight, and particularly preferably from 97 to 98.75 parts by weight, of a thermoplastic aromatic polyester,

b) from 5 to 0.5 parts by weight, preferably from 4 to 1 parts by weight, particularly preferably from 3 to 1.25 parts by weight, of a monocarboxylic acid, where the total of the parts by weight of a) and b) is 100;

c) from 0.5 to 60% by weight, preferably from 2 to 55% by weight, and particularly preferably from 4 to 50% by weight, in each case based on the molding composition, of particulate, lamellar and/or fibrous additives, selected from fillers, pigments, reinforcing materials, additives which give the molding composition antielectrostatic properties or electrical conductivity, nucleating agents, and particulate flame retardants,

d) from 0 to 30% by weight of a non-particulate flame retardant,

e) from 0 to 20% by weight of a synergist, and

f) from 0 to 5% by weight of other additives and/or processing aids, where the solution viscosity of the resultant polyester molding composition, measured as J value according to DIN 53 728/ISO 1628/Part 5, is in the range from 50 to 80 cm³/g, and preferably from 52 to 70 cm³/g, the melt index of the molding composition, measured as MVR at 250° C./5 kg to DIN EN ISO 1133 is from 12 to 60 cm³/10 min, preferably from 15 to 50 cm³/10 min, particularly preferably from 20 to 40 cm³/10 min, and very particularly preferably from 20 to 35 cm³/10 min.

Thermoplastic polyesters are prepared by polycondensing diols with dicarboxylic acids or with their polyester-forming derivatives, such as dimethyl esters. Suitable diols have the formula HO—R—OH, where R is a divalent, branched or unbranched aliphatic and/or cycloaliphatic radical having from 2 to 40, preferably from 2 to 12, carbon atoms. Suitable dicarboxylic acids have the formula HOOC—R′—COOH, where R′ is a divalent aromatic radical having from 6 to 20 carbon atoms, preferably from 6 to 12 carbon atoms.

Examples of diols are ethylene glycol, trimethylene glycol, tetramethylene glycol, but-2-ene-1,4-diol, hexamethylene glycol, neopentyl glycol, cyclohexanedimethanol, and the C₃₆ diol dimerdiol. The diols may be used alone or as a diol mixture.

Examples of aromatic dicarboxylic acids which may be used are terephthalic acid, isophthalic acid, 1,4-, 1,5-, 2,6-, and 2,7-naphthalenedicarboxylic acid, biphenyl-4,4′-dicarboxylic acid, and diphenyl ether 4,4′-dicarboxylic acid. Up to 30 mol % of these dicarboxylic acids may be replaced by aliphatic or cycloaliphatic dicarboxylic acids having from 3 to 50 carbon atoms, and preferably having from 6 to 40 carbon atoms, e.g. succinic acid, adipic acid, sebacic acid, dodecanedioic acid, or cyclohexane-1,4-dicarboxylic acid.

Examples of suitable polyesters are polyethylene terephthalate, polypropylene terephthalate, polybutylene terephthalate, polyethylene 2,6-naphthalate, polypropylene 2,6-naphthalate, and polybutylene 2,6-naphthalate.

The preparation of these polyesters is described in the prior art (DE-A 24 07 155, 24 07 156; Ullmann's Enzyklopädie der technischen Chemie [Ullmann's Encyclopedia of Technical Chemistry], 4th edition, Volume 19, pp. 65 et seq., Verlag Chemie, Weinheim, 1980).

In principle, any acid of the formula

R″—COOH

may be used as the monocarboxylic acid. R″ is an aliphatic, cycloaliphatic, or aromatic radical; it preferably has at least 5 carbon atoms. Examples of compounds which may be used, either alone or as a mixture, are hexanecarboxylic acid, 2-ethylhexanecarboxylic acid, stearic acid, cyclohexanecarboxylic acid, benzoic acid, o-, m- or p-methylbenzoic acid, tert-butylbenzoic acid, p-phenylbenzoic acid, p-phenoxybenzoic acid, and naphthalene-2-carboxylic acid.

The polyester molding composition may comprise up to 60% by weight, preferably up to 55% by weight, and particularly preferably from 4 to 50% by weight, of fibrous, lamellar, or particulate fillers or reinforcing agents or mixtures of these materials.

Examples of fibrous fillers or fibrous reinforcing materials are glass fibers, carbon fibers, aramid fibers, potassium titanate fibers, and fibrous silicates, such as wollastonite.

Examples of lamellar fillers or lamellar reinforcing materials are mica, talc, and graphite.

Examples of particulate fillers or particulate reinforcing materials are glass beads, powdered quartz, kaolin, boron nitride, calcium carbonate, barium sulfate, silicates, silicon nitride, titanium dioxide, carbon black, and also oxides or oxide hydrates of magnesium or aluminum.

The polyester molding composition may comprise from 0 to 30% by weight, and preferably from 0.1 to 25% by weight, of non-particulate flame retardants. Use may be made here of any of the flame retardants which are usually used for polyester molding compositions. Examples of suitable flame retardants, either particulate [component c)] or non-particulate [component d)], are polyhalobiphenyl, polyhalodiphenyl ether, polyhalophthalic acid and its derivatives, polyhalooligo- and -polycarbonates, and halogenated polystyrenes, the corresponding bromine compounds being particularly effective; melamine cyanurate, melamine phosphate, melamine pyrophosphate, elemental red phosphorus; organophosphorus compounds, such as phosphonates, phosphinates, phosphinites; phosphine oxides, such as triphenylphosphine oxide; phosphines, phosphites, and phosphates, such as triphenyl phosphate. Other suitable flame retardants are compounds which contain phosphorus-nitrogen bonds, such as phosphonitrile dichloride, phosphoric ester amides, phosphoramides, phosphonamides, phosphinamides, tris(aziridinyl)phosphine oxide, or tetrakis(hydroxymethyl)-phosphonium chloride, or else fillers which release water in the event of a fire, for example magnesium hydroxide or aluminum hydroxide.

If a flame retardant is used, concomitant use may be made of up to 20% by weight, preferably from 0.1 to 15% by weight, of a synergist. Examples which may be mentioned of these synergists are compounds of cadmium, of zinc, of aluminum, of silver, of iron, of copper, of antimony, of tin, of magnesium, of manganese, of vanadium, and of boron. Examples of particularly suitable compounds are oxides of the metals mentioned, and also carbonates or oxycarbonates, hydroxides, and also salts of organic or inorganic acids, for example acetates, phosphates or hydrogenphosphates, or sulfates.

Besides, the molding composition may comprise other additives and/or processing aids, such as antioxidants, heat stabilizers, light stabilizers, dyes, pigments, lubricants, mold-release agents, or flow promoters.

The polyester molding composition may be prepared by known processes, by mixing the starting components in conventional mixers, in particular twin-screw extruders, and then extruding them. The extrudate is cooled, pelletized, and dried.

The solution viscosity of the polyester molding composition is measured according to DIN 53 728/ISO 1628/Part 5, on a 0.5% strength by weight solution of the polyester in a phenol/1,2-dichlorobenzene mixture (ratio 1:1 by weight) at 25° C. An appropriate amount of the molding composition is weighed out to prepare the solution; insoluble constituents are then removed by filtration or centrifuging.

The molding composition of the invention is particularly advantageously used for moldings with small dimensions, in particular injection moldings, for example for relay components, capacitor cups, plug connectors, semiconductor housings, multipoint connectors, or SMD components.

Having generally described this invention, a further understanding can be obtained by reference to certain specific examples which are provided herein for purposes of illustration only and are not intended to be limiting unless otherwise specified.

### COMPARATIVE EXAMPLE 1

Standard Molding Composition

The following materials were fed into the first intake of a Werner & Pfleiderer ZSK 30 M9/1 twin-screw kneader:

83 parts by weight of VESTODUR® 1000, a polybutylene terephthalate from Degussa AG with solution viscosity J=107 cm³/g,

14 parts by weight of antimony oxide (synergist),

0.5 part by weight of a commercially available processing stabilizer,

0.5 part by weight of a commercially available heat stabilizer, and

15 parts by weight of a color concentrate from 15% by weight of carbon black and 85% by weight of VESTODUR® 1000, and then

105 parts by weight of glass fibers and

17.5 parts by weight of a commercially available bromine-containing flame retardant were fed into the second intake. Melt temperature was 280° C. and rotation rate was 250 rpm. The product was extruded, pelletized, and dried for 4 hours at 120° C.

The results of testing are given in Table 1.

### COMPARATIVE EXAMPLE 2

As Comparative Example 1, with the sole difference that the 83 parts by weight of VESTODUR® 1000 were replaced by 83 parts by weight of a corresponding low-molecular-weight polybutylene terephthalate (J=80 cm³/g).

### COMPARATIVE EXAMPLE 3

As Comparative Example 1, with the sole difference that 1.5 parts by weight of terephthalic acid were included in the addition at the first intake.

### COMPARATIVE EXAMPLE 4

As Comparative Example 1, with the sole difference that 2 parts by weight of terephthalic acid were included in the addition at the first intake.

### EXAMPLE 1

As Comparative Example 1, with the sole difference that 1.75 parts by weight of benzoic acid were included in the addition at the first intake.

### EXAMPLE 2

As Comparative Example 1, with the sole difference that 2.25 parts by weight of benzoic acid were included in the addition at the first intake.

It is seen from Table 1 that the mechanical properties of the molding composition of the invention (Examples 1 and 2) are similar or somewhat better than those of a molding composition in which a low-molecular-weight specialty polyester grade was used (Comparative Example 2), while flowability was comparable, and that moreover the improvement in flowability brought about by addition of a monocarboxylic acid is considerably greater than when a comparable amount of a dicarboxylic acid is added. Despite the considerably improved flowability, which per se would promote dropping, in the fire test according to UL 94 the material is still graded as fire class V-0.

The disclosure of priority German application 10200804.3, filed Jan. 11, 2002, is hereby incorporated by reference.

TABLE 1
Results of tests

| | Comparative | Comparative | Comparative | Comparative | | |
|---|---|---|---|---|---|---|
| Tests | Example 1 | Example 2 | Example 3 | Example 4 | Example 1 | Example 2 |
| Solution viscosity [cm³/g] ISO 1628/5 | 88 | 67 | 87 | 77 | 79 | 53 |
| Impact strength ISO 179/1eU, | 68 | 35 | 57 | The pellets | 40 | 38 |
| 23° C. [kJ/m²] | | | | were | | |
| Notch impact strength ISO 179/1eA, | 11.5 | 10.8 | 10 | extremely | 12 | 9.5 |
| 23° C. [kJ/m²] | | | | brittle! | | |
| Tensile test ISO 527: Tensile stress at | 141 | 92 | 139 | Experiment | 110 | 101 |
| break | | | | was | | |
| Spiral flow^{a)}, 6 × 2 mm [length in mm] | 394 | 812 | 451 | terminated | 661 | 820 |
| MVR (250° C./5 kg) [cm³/10 min] | 11 | 36 | ^{b)} | | 13 | 26 |
| DIN EN ISO 1133 | | | | | | |
| Fire performance UL 94 0.8 mm | V-0 | V-0 | V-0 | | V-0 | V-0 |

^{a)}Melt temperature 260° C., mold temperature 80° C., injection pressure 1200 bar, maximum flow front velocity 950 mm/s
^{b)}Not measured

What is claimed is:

1. A molding composition which comprises the following components:
a) from 95 to 99.5 parts by weight of a thermoplastic aromatic polyester,
b) from 5 to 0.5 parts by weight of a monocarboxylic acid, where the total of the parts by weight of a) and b) is 100;
c) from 0.5 to 60% by weight, based on the molding composition, of particulate, lamellar and/or fibrous additives, selected from the group consisting of fillers, pigments, reinforcing materials, additives which give the molding composition antielectrostatic properties or electrical conductivity, nucleating agents, and particulate flame retardants,
where the solution viscosity, measured as J value according to DIN 53 728/ISO 1628/Part 5, is in the range from 50 to 80 cm³/g, and the melt index of the molding composition, measured as MVR at 250° C./5 kg, is from 12 to 60 cm³/10 min.

2. The molding composition as claimed in claim 1, which also comprises at least one of
d) not more than 30% by weight of a flame retardant,
e) not more than 20% by weight of a synergist, and
f) not more than 5% by weight of other additives and/or processing aids.

3. The molding composition as claimed in claim 1, wherein the solution viscosity is in the range from 52 to 70 cm³/g.

4. The molding composition as claimed in claim 1, which has a melt index at 250° C./5 kg of from 15 to 50 cm³/10 min.

5. The molding composition as claimed in claim 4, which has a melt index at 250° C./5 kg of from 20 to 40 cm³/10 min.

6. The molding composition as claimed in claim 5, which has a melt index at 250° C./5 kg of from 20 to 35 cm³/10 min.

7. The molding composition as claimed in claim 1, wherein the polyester is selected from the group consisting of polyethylene terephthalate, polypropylene terephthalate, polybutylene terephthalate, polyethylene 2,6-naphthalate, polypropylene 2,6-naphthalate, and polybutylene 2,6-naphthalate.

8. A molding produced from the molding composition as claimed in claim 1.

9. A molding produced from the molding composition as claimed in claim 2.

10. A molding produced from the molding composition as claimed in claim 3.

11. A molding produced from the molding composition as claimed in claim 4.

12. A molding produced from the molding composition as claimed in claim 5.

13. A molding produced from the molding composition as claimed in claim 6.

14. A molding produced from the molding composition as claimed in claim 7.

15. The molding as claimed in claim 8, produced by injection molding.

16. The molding as claimed in claim 8, which is a relay component, a capacitor cup, a plug connector, a semiconductor housing, a multipoint connector, or an SMD component.

17. The molding as claimed in claim 15, which is a relay component, a capacitor cup, a plug connector, a semiconductor housing, a multipoint connector, or an SMD component.

18. A method comprising molding with the molding composition of claim 1.

19. The method as claimed in claim 18, wherein the molding is injection molding.

20. The method as claimed in claim 18, wherein the molding results in a product which is a relay component, a capacitor cup, a plug connector, a semiconductor housing, a multipoint connector, or an SMD component.
